(19) United States
(12) Patent Application Publication
(10) Pub. No.: US 2012/0231644 A1
(43) Pub. Date: Sep. 13, 2012

(54) VEHICLE CHARGE CABLE SOCKET CONNECTOR

(75) Inventor: Katsuhiro KINOSHITA, Toyama (JP)

(73) Assignee: SMK CORPORATION, Tokyo (JP)

(21) Appl. No.: 13/406,541

(22) Filed: Feb. 28, 2012

(30) Foreign Application Priority Data
Mar. 10, 2011 (JP) 2011-073487

(51) Int. Cl. H01R 4/60

(52) U.S. Cl. 439/205

(57) ABSTRACT

Electrical connection reliability of a vehicle charge cable socket connector is maintained for a long period. Dust particles and rain drops that inevitably get into a socket contact can be let out through a contact through hole and a housing through hole that extend from inside the socket contact to outside a housing. Such a configuration can avoid adverse effects of dust particles and drain drops on electrical contact and maintain high connection reliability for a long period.

### CROSS REFERENCE TO RELATED APPLICATION

The contents of the following Japanese patent application are incorporated herein by reference,
NO. 2011-073487 filed on Mar. 10, 2011.

### BACKGROUND

1. Technical Field

The present invention relates to a charge cable connector for use in charging a vehicle on which a secondary battery is mounted, such as an electric vehicle.

2. Description of the Related Art

Nowadays, ecologically-friendly vehicles such as electric vehicles and plug-in hybrid vehicles are becoming prevalent that use a motor as their main source of driving force and on which a secondary battery is mounted as a means for supplying electric power to the motor. A typical method of charging such a vehicle-mounted secondary battery is to connect the vehicle and a predetermined charger with a charge cable and supply electric power from the charger to the vehicle for charging. Such a charging method requires the provision of connectors that detachably engage the charge port on the vehicle side with the charge cable for mutual electrical connection.

For ease of description, a connector provided on the vehicle side will hereinafter be referred to as a “plug connector,” and a connector arranged at the end of the charge cable a “socket connector.” Electrical connection terminals of the plug connector and socket connector will be referred to as “plug contacts” and “socket contacts,” respectively.

Socket contacts often have a cylindrical shape. Plug contacts of pin shape, formed on an opposed plug connector, are inserted into the interiors of the cylindrical socket contacts. The inner peripheries of the socket contacts and the outer peripheries of the plug contacts thereby come into contact with each other for electric conduction. The shape of the socket contacts will be described in more detail. For example, as shown in Japanese Patent No. 3195181 (in particular, FIGS. 1 to 3), a charge connector terminal 11 is typically opened at a side from which a male terminal 21 is inserted, and closed at a bottom end in the direction of insertion. The charge connector terminal 11 is connected to an end of a wire 25, which leads to a cable, by a wire connection part 23 that lies behind.

Vehicles are usually charged outdoors. Dust particles can hinder electric conduction between socket contacts and plug contacts. Rain drops can promote erosion of the contact surfaces on the socket contacts and plug contacts. For the purpose of ensuring the electrical connection reliability of the charge cable connector for high-voltage high-current power supply, measures against dust particles and rain drops are indispensable. Various proposals have been made heretofore on this subject. For example, Japanese Patent No. 3195181 discloses an example where an O ring 31 is arranged near an insertion opening 15 of the charge connector terminal 11. When the male terminal 21 is inserted into the charge connector terminal 11, the O ring 31 prevents intrusion of muddy water and the like adhering to the outer periphery of the male terminal 21 (see FIG. 8).

With such a method as disclosed in Japanese Patent No. 3195181, however, it is not possible to let out muddy water and the like that fail to be removed by the O ring and get into the socket contact when mating and unmating the charge cable. The possibility of the foregoing problem has not been successfully dispelled yet.

### SUMMARY

The present invention has been achieved in order to solve the foregoing problem. It is thus an object of the present invention to provide a vehicle charge cable socket connector which avoids the adverse effects of dust particles and rain drops entering the interior of a socket contact upon electrical contact, and maintains high electrical connection reliability for a long period even in outdoor use.

To solve the foregoing problem, a vehicle charge cable socket connector according to claim 1 of the present invention includes: a socket contact that makes contact with a plug contact; and a housing that includes a holding part for holding the socket contact. The socket contact includes a bottom part to be held at by the housing, and an elastic contact piece that extends from the bottom part and comes into elastic contact with a plug connector-side contact. The bottom part includes a hollow that is formed inside, and a socket contact through hole that runs through to extend from the hollow to outside the socket contact. The housing includes a socket contact accommodation part that accommodates the socket contact, and a housing through hole that opens at one end so as to be opposed to the socket contact through hole and opens at the other end to outside the socket connector. Consequently, there is formed a through hole that extends from inside the socket contact to outside the socket connector.

In a vehicle charge cable socket connector according to claim 2 of the present invention, an outer periphery of the elastic contact piece is covered with a contact cover. The contact cover includes an elastic contact piece accommodation part that accommodates the elastic contact piece, an insertion hole that is formed in an end of the elastic contact piece accommodation part and through which the plug contact passes, and an end annular part that is arranged around the insertion hole. The contact accommodation part includes an end narrow-necked part in whose end an opening for the plug connector-side contact to pass through is formed. The end annular part is in contact with the end narrow-necked part.

In a vehicle charge cable socket connector according to claim 3 of the present invention, the elastic contact piece is formed by splitting an end part of the socket contact by a split that extends from the end of the socket contact. The contact cover includes a rib part that is formed inside the elastic contact piece accommodation part so as to correspond to arrangement of the split. The rib part is in close contact with end faces of the split.

In a vehicle charge cable socket connector according to claim 4 of the present invention, the bottom part is cylindrical in shape and includes a notch that is formed by cutting away a part of an outer periphery of the cylindrical bottom part. The holding part has a shape corresponding to that of the outer periphery of the bottom part with the notch. The socket contact is thereby held with its rotation with respect to the housing restricted.

According to the invention set forth in claim 1, dust particles and rain drops that enter the interior of the socket contact can be let out through the through hole that extends from inside the socket contact to outside the housing. It is therefore possible to maintain high electrical connection reliability for a long period without adding dustproof or drip-proof members.

According to the invention set forth in claim 2, the elastic contact piece is covered with the contact cover, and the end annular part of the contact cover is in contact with the inner side of the end narrow-necked part of the contact accommodation part. Such a configuration can effectively prevent dust particles and rain drops from entering the contact accommodation part. Since no dust particles or rain drops reside in the contact accommodation part, it is possible to prevent dust particles and rain drops from returning to inside the elastic contact piece to affect the electrical contact. High electrical connection reliability can thus be maintained for an even longer period.

According to the invention set forth in claim 3, when the elastic contact piece is formed by splitting the end part of the socket contact, the split can be stopped up with the rib that is formed on the contact cover. With such a structure, dust particles and rain drops that enter the interior of the socket contact are guided into the through hole without being reserved in the split, whereby the socket contact is kept clean inside. High electrical connection reliability can thus be maintained for an even longer period.

According to the invention set forth in claim 4, the socket contact has a cylindrical bottom part, and the rotation of the socket contact with respect to the housing is restricted. The socket connector can thus be assembled so that the contact through hole and the housing through hole are opposed to each other without fail. Consequently, dust particles and rain drops that enter the interior of the socket contact can be smoothly let out.

### BRIEF DESCRIPTION OF THE DRAWINGS

FIG. 1 is a perspective view showing the appearance of a vehicle charge cable socket connector according to an embodiment of the present invention;

FIG. 2 is a front view showing the vehicle charge cable socket connector according to the embodiment of the present invention;

FIG. 3 is a perspective view showing the appearance of the vehicle charge cable socket connector according to the embodiment of the present invention in a different angle, along with a plug connector (vehicle side);

FIGS. 4A and 4B are diagrams showing a socket contact of the vehicle charge cable socket connector according to the embodiment of the present invention, FIG. 4A being a perspective view showing the appearance of the socket contact, FIG. 4B being a central longitudinal sectional view;

FIGS. 5A to 5C are diagrams showing a socket contact of the vehicle charge cable socket connector according to the embodiment of the present invention along with a contact cover, FIG. 5A being a perspective view of the appearance, FIG. 5B being a central longitudinal sectional view, FIG. 5C being a cross-sectional view of essential parts;

FIG. 6 is a sectional view of the vehicle charge cable socket connector according to the embodiment of the present invention, taken along line A-A of FIG. 2;

FIG. 7 is a sectional view of the vehicle charge cable socket connector according to the embodiment of the present invention, taken along line B-B of FIG. 6; and

FIG. 8 is a diagram showing an example of a conventional vehicle charge cable socket connector.

### DESCRIPTION OF EXEMPLARY EMBODIMENTS

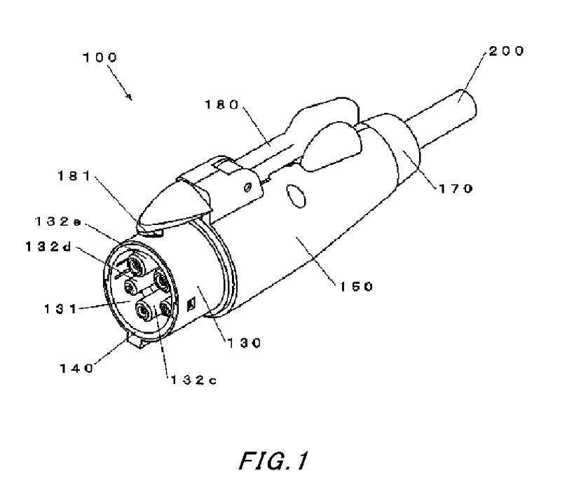

A vehicle charge cable socket connector 100 according to an embodiment of the present invention will be described below with reference to FIGS. 1 to 7. In the drawings, a charge cable 200 is shown only in part. The other end of the charge cable 200 is connected to a not-shown charger.

FIG. 1 shows the appearance of the vehicle charge cable socket connector 100 according to the embodiment of the present invention. The socket connector 100 is attached to an end of a charge cable 200 in a watertight manner via an elastic bushing 170. A cylindrical housing 130 is exposed in part at an end portion of the socket connector 100. The interior of the cylindrical end portion constitutes a plug connector accommodation part 131. The plug connector accommodation part 131 accommodates a plug connector 300 to be described later when the plug connector 300 is connected.

In the present embodiment, the body section extending from the plug connector accommodation part 131 to the busing 170 is composed of a combination of a right cover 150 and a left cover 160 which are separated along the center line. The socket connector 100 can be assembled by fastening the right cover 150 and the left cover 160 with a screw, with the outer peripheries of the housing 130 and the bushing 170 sandwiched between the right cover 150 and the left cover 160. In the present embodiment, a ring member 140 separate from the housing 130 is arranged inside the plug connector accommodation part 131. The ring 140 is intended to improve breaking strength against stress from the insertion of the socket connector 100 into the plug connector 300 and the withdrawal of the socket connector 100 from the plug connector 300. The ring member 140, however, is not indispensable.

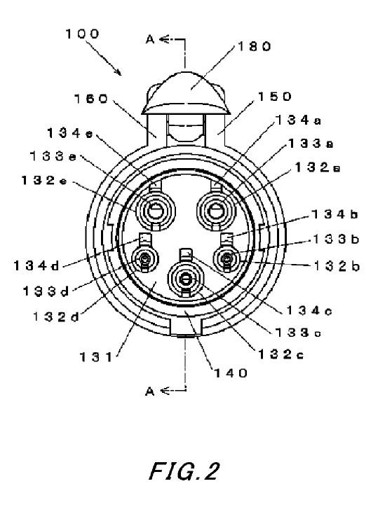

As shown in FIG. 2, the plug connector accommodation part 131 includes contact accommodation parts 132a to 132e of cylindrical shape, which are arranged in a predetermined positional relationship that is defined by an industrial standard. In the present embodiment, there are arranged a total of five contact accommodation parts 132a to 132e, including a power supply positive electrode, a ground electrode, and a charge control signal electrode. The contact accommodation parts 132a to 132e each contain a socket contact 110.

A lock lever 180 for securely maintaining the connection with the plug connector 300 is arranged at the top of the socket connector 100. A latch part 181 protruding downward is formed at the end of the lock lever 180. The lock lever 180 is pivotally supported by bearing holes formed in the right cover 150 and the left cover 160, respectively, so as to be movable in a seesaw fashion. A coil spring 182 to be described later biases the lock lever 180 in a direction such that the latch part 181 approaches the plug connector accommodation part 131.

The housing 130, the ring member 140, the right cover 150, the left cover 160, and the lock lever 180 described above are all molded of an insulating synthetic resin.

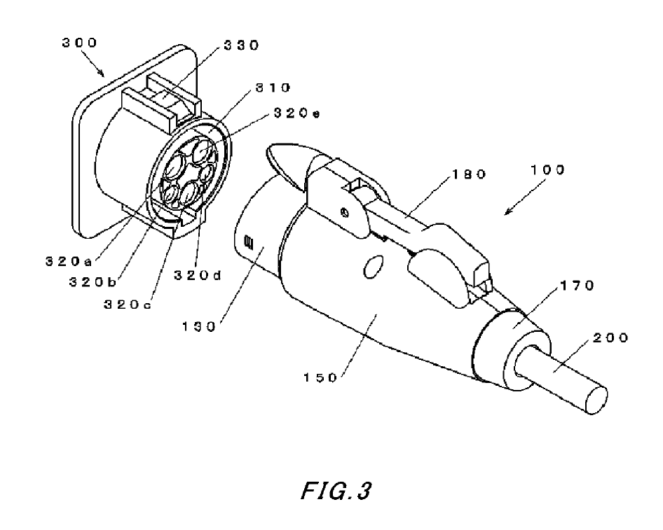

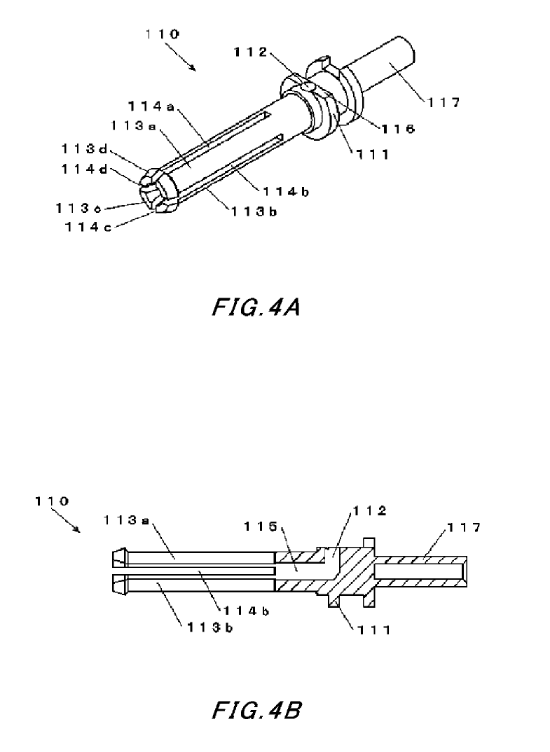

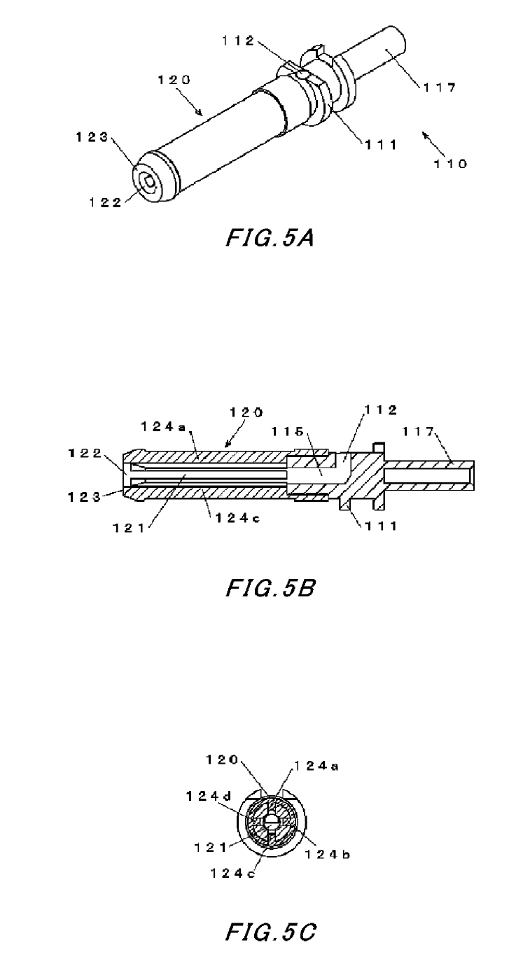

FIG. 3 shows the appearance of the present embodiment as seen from behind, along with the plug connector 300 to be mated. The plug connector 300 is fixed to the vehicle side. The plug connector 300 has an annular recess 310 for the cylindrical portion of the plug connector accommodation part 131 to be inserted into. The plug connector 300 also has plug contact arrangement holes 320a to 320e in positions corresponding to the contact accommodation parts 132a to 132e of the socket connector 100, respectively. Not-shown plug contacts of pin shape are arranged on the bottoms of the plug contact arrangement holes 320a to 320e.

A to-be-latched part 330 is arranged at the top of the plug connector 300. When the socket connector 100 is inserted into the plug connector 300, the to-be-latched part 330 and the foregoing latch part 181 come into engagement with each other. The plug connector 300 and the socket connector 100 are thereby retained so as not to be detachable. To withdraw the socket connector 100 from the plug connector 300, the lock lever 180 is gripped in the portion closer to the bushing 170 and pushed down against the biasing force of the coil spring 182. The latch part 181 is thereby moved upward to release the engagement with the to-be-latched part 330, which makes withdrawal possible.

FIGS. 4A and 4B show a socket contact 110. The socket contact 110 is made of elastic conductive metal. The socket contact 110 is cylindrical in shape, and includes elastic contact pieces 113a to 113d, a bottom part 111, and a wire connection part 117 in order from the end side (the side from which a plug contact is inserted). The elastic contact pieces 113a to 113d are formed by splitting the end portion of the socket contact 110 crisscross by four splits 114a to 114d which extend from the end. The elastic contact pieces 113a to 113d are configured so that their ends can make a radially outward elastic displacement with the bottom part 111 as a fulcrum. A plug contact (not shown) has a columnar pin shape, with a diameter somewhat greater than that of the circle that the inner peripheries of the elastic contact pieces 113a to 113d form. When the plug contact is inserted into the socket contact 110, the elastic contact pieces 113a to 113d each make elastic contact with the outer periphery of the plug contact for electric conduction therebetween.

The bottom part 111 has a hollow 115 inside. The hollow 115 extends from near the fulcrum of the elastic contact pieces 113a to 113d to the vicinity of the center of the bottom part 111. A contact through hole 112 is also formed in the vicinity of the center of the bottom part 111. The contact through hole 112 extends from the outer periphery of the bottom part 111 to the hollow 115. In the present embodiment, two collar-like portions are arranged around the bottom part 111. One of the collar-like portions, lying closer to the end side, is partly cut away to form a so-called D-cut shape, or a notch 116. The wire connection part 117 is formed in a cylindrical shape, extended from the bottom part 111. An end of a wire 210 included in the charge cable 200 is inserted into the interior of the wire connection part 117, and soldered to connect the socket contact 110 and the wire 210.

FIGS. 5A to 5C show a socket contact 110 which is covered with a contact cover 120. In the present embodiment, the contact cover 120 is molded of silicone rubber which is an insulating elastic material. The contact cover 120 has a generally cylindrical shape. An elastic contact piece accommodation part 121 inside the cylinder accommodates the elastic contact pieces 113a to 113d, thereby covering the socket contact 110 from the end to near the contact through hole 112 in the outer periphery of the bottom part 111. The end portion of the contact cover 120 has an insertion hole 122 for a plug contact to pass through. The insertion hole 122 is surrounded by an end annular part 123 which is constituted by a plane perpendicular to the longitudinal direction of the socket contact 110.

As can be seen from FIG. 5C, the elastic contact piece accommodation part 121 has four rib parts 124a to 124d inside. The rib parts 124a to 124d are vertically erected from the inner periphery of the contact cover 120 so as to correspond to the arrangement of the splits 114a to 114d. With the contact cover 120 alone (when not attached to any socket contact), all the four rib parts 124a to 124d have a thickness somewhat greater than the width of the splits 114a to 114d when a plug contact is inserted into the socket contact 110. Such setting of the rib parts 124a to 124d in thickness makes it possible to maintain the end faces of the splits 114a to 114d and the rib parts 124a to 124d in close contact with each other even when a plug contact is inserted into the socket contact 110. This can effectively prevent dust particles and rain drops from residing between the end faces of the splits 114a to 114d and the rib parts 124a to 124d.

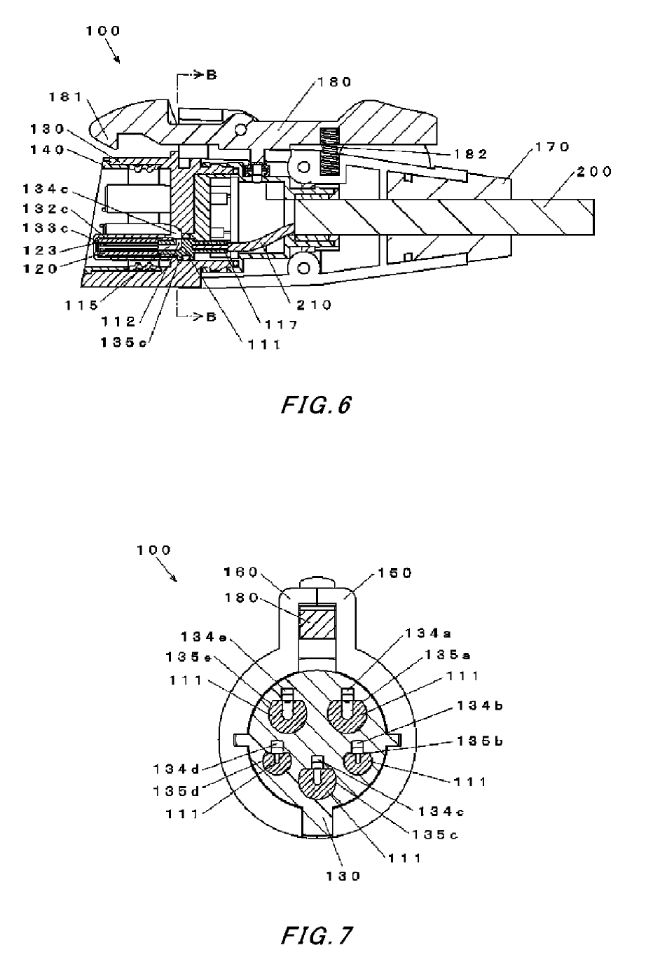

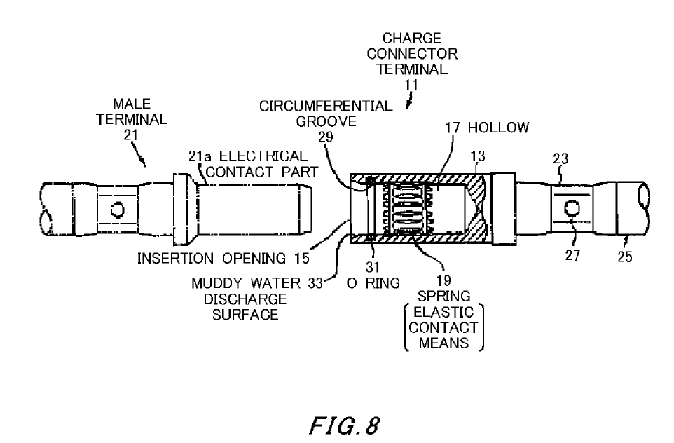

FIG. 6 is a central longitudinal sectional view of the present embodiment. As an example, the following description details the contact accommodation part 132c which is arranged at the bottom center when seen in a front view. The other contact accommodation parts 132a, 132b, 132d, and 132e have the same configuration.

As can be seen from FIG. 6, there is formed a through hole in the vicinity of the bottom part 111, the through hole extending from the hollow 115 to the plug connector accommodation part 131 via the contact through hole 112 and a housing through hole 134. Dust particles and rain drops that enter the interior of the socket contact 110 are let out from the socket connector 100 via the through hole. This prevents dust particles and rain drops from affecting electrical contact.

The socket contact 110 is supplied with a high voltage. In order to prevent users from touching the socket contact 110 and receiving an electric shock, the cylindrical contact accommodation unit 132c is integrally formed on the housing 130 so as to protrude toward the end. The contact accommodation part 132c has an end narrow-necked part 133c at its end. The end narrow-necked part 133c covers the end of the socket contact 110 to avoid exposure. In the present embodiment, the inner surface of the end narrow-necked part 133c and the end annular part 123 of the contact cover 120 are in contact with each other. This can prevent dust particles and rain drops from entering the interior of the contact accommodation part 132c through a gap between the inner surface of the end narrow-necked part 133c and the end annular part 123 of the contact cover 120. Since no dust particles or rain drops reside in the contact accommodation part 132c, it is possible to prevent dust particles and rain drops from returning to the contact portion to affect electrical contact.

The socket contact 110 is fixed to the housing 130 by pressing the bottom part 111 into a holding part 135c from the rear side of the housing 130 to the front side. The shapes of the bottom part 111 and the holding part 135c will be described later. The coil spring 182 is intended to bias the lock lever 180 as described above. An end of the coil spring 182 is fixed to a hole that is formed when the right cover 150 and the left cover 160 are combined. The other end is fixed to a hole that is formed in the bottom of the lock lever 180.

FIG. 7 is a cross-sectional view showing essential parts including notches 116 according to the present embodiment. The bottom parts 111 of the five socket contacts 110 have similar shapes, each having the same notch 116 as described previously. Holding parts 135a to 135e are formed by making holes in the housing 130, with the same shapes as the outer shapes of the bottom parts 111 including the notches 116. When the socket contacts 110 are pressed into the respective holding parts 135a to 135e, the socket contacts 110 are fixed so as not to be rotatable. The contact through holes 112 and the housing through holes 134a to 134e are thereby opposed to each other in a favorable position, and are maintained in that state.

The foregoing embodiment has dealt with the case where the socket connector is shaped straight from its end to the charge cable, i.e., the socket connector is of so-called straight type. However, the range of application of the present invention is not limited thereto. The present invention is suitably applicable to a socket connector of a type where the socket connector is curved into a generally L shape from its end to the charge cable.

The present invention may be applied to a charge cable socket connector for use in charging a vehicle on which a secondary battery is mounted, such as an electric vehicle. The present invention thereby contributes to a reduction of charging troubles due to dust particles, rain drops, and the like entering inside the connector.

What is claimed is:

1. An electric vehicle charge cable socket connector provided to an end of a charge cable for use in charging an electric vehicle, the socket connector being connected with a plug connector provided to the electric vehicle for electric connection, the socket connector comprising:
a socket contact that makes contact with a plug connector-side contact; and
a housing that includes a holding part for holding the socket contact,
the socket contact including
a bottom part to be held at by the housing, and
an elastic contact piece that extends from the bottom part and comes into elastic contact with the plug connector-side contact,
the bottom part including
a hollow that is formed inside, and
a socket contact through hole that runs through to extend from the hollow to outside the bottom part,
the housing including
a socket contact accommodation part that accommodates the socket contact, and
a housing through hole that opens at one end so as to be opposed to the socket contact through hole and opens at the other end to outside the socket connector.

2. The electric vehicle charge cable socket connector according to claim 1, wherein:
an outer periphery of the elastic contact piece is covered with a contact cover;
the contact cover includes
an elastic contact piece accommodation part that accommodates the elastic contact piece,
an insertion hole that is formed in an end of the elastic contact piece accommodation part and through which the plug connector-side contact passes, and
an end annular part that is arranged around the insertion hole;
the contact accommodation part includes
an end narrow-necked part in whose end an opening for the plug connector-side contact to pass through is formed; and
the end annular part is in contact with the end narrow-necked part.

3. The electric vehicle charge cable socket connector according to claim 2, wherein:
the elastic contact piece is formed by splitting an end part of the socket contact by a split that extends from the end of the socket contact;
the contact cover includes a rib part that is formed inside the elastic contact piece accommodation part so as to correspond to arrangement of the split; and
the rib part is in close contact with end faces of the split.

4. The electric vehicle charge cable socket connector according to claim 1, wherein:
the bottom part is cylindrical in shape and includes a notch that is formed by cutting away a part of an outer periphery of the cylindrical bottom part;
the holding part has a shape corresponding to that of an outer periphery of the bottom part with the notch; and
the socket contact is held with its rotation with respect to the housing restricted.
